(19) United States
(12) Patent Application Publication
(10) Pub. No.: US 2026/0161686 A1
(43) Pub. Date: Jun. 11, 2026

(54) SYSTEMS AND METHODS FOR AUTOMATED CLIENT-BASED ARTIFICIAL INTELLIGENCE AGENT INTEGRATION AND INTERFACES

(71) Applicant: Ensureing Inc., New York, NY (US)

(72) Inventor: Rajeev Dhillon, Danbury, CT (US)

(21) Appl. No.: 19/410,310

(22) Filed: Dec. 5, 2025

Related U.S. Application Data
(60) Provisional application No. 63/728,357, filed on Dec. 5, 2024.

(51) Int. Cl. G06F 16/3329; G06F 16/338; G06T 13/40

(52) U.S. Cl. CPC G06F 16/33295; G06F 16/338; G06T 13/40

(57) ABSTRACT

The present disclosure relates generally to systems and methods for the generation and deployment of automated artificial intelligence agents that are implemented to communicate with different users through trained machine learning and artificial intelligence techniques.

### CROSS-REFERENCE TO RELATED APPLICATIONS

The present application claims the priority benefit of U.S. Provisional Application No. 63/728,357, filed on Dec. 5, 2024, the disclosure of which is incorporated herein by reference.

### FIELD

The present disclosure relates generally to systems and methods for the generation and deployment of automated artificial intelligence agents and client-based artificial intelligence agents that are implemented to communicate with different users through trained machine learning and artificial intelligence techniques.

### BACKGROUND

Companies and organizations often rely on agents to communicate with different users with regard to different services provided by these companies and organizations. These agents are usually human actors that, for different reasons, may be unable to maintain constant contact with these different users. For instance, certain companies and organizations may have high turnover rates, such that an original agent that a user has interacted with is no longer available. As another example, a user that moved geographically away from their original agent may no longer be able to interact with the original agent. In such instances, it may be difficult for a user to address any issues related to any resources or services provided by these companies and organizations, resulting in a negative user experience. These issues may be prevalent in various industries, such as in the insurance industry where users may be orphaned and may no longer have contact or other interactions with their original agents.

### SUMMARY

Disclosed embodiments provide a framework through which automated artificial intelligence agents are implemented to dynamically communicate with different users to address different issues. According to some embodiments, a computer-implemented method is provided. The computer-implemented method comprises receiving a user query through an agent interface associated with an automated artificial intelligence agent. The agent interface includes a text-based messaging window and a virtual avatar associated with the automated artificial intelligence agent. The computer-implemented method further comprises processing the user query through a Natural Language Processing (NLP) system to generate a set of query embeddings. The computer-implemented method further comprises processing the set of query embeddings through a response generation large language model (LLM) to identify a set of response embeddings. The set of response embeddings corresponds to a set of data sources associated with the user query. Further, the set of response embeddings is identified based on a comparison of different dimensional values associated with the set of query embeddings and the set of response embeddings according to a set of vectors of similarity. The computer-implemented method further comprises generating a programmatic script for presenting a response to the user query. The response is generated based on the set of response embeddings. Further, the programmatic script defines configurable parameters associated with the virtual avatar. The computer-implemented method further comprises providing the programmatic script. When the programmatic script is executed by the automated artificial intelligence agent, the agent interface is updated to present the response through the text-based messaging window and the virtual avatar is animated according to the configurable parameters and in tandem with a vocalization of the response.

In some embodiments, the computer-implemented method further comprises receiving a new user query through the agent interface. The computer-implemented method further comprises determining, through the response generation LLM, that a new set of query embeddings corresponding to the new user query is associated with a known set of embeddings corresponding to impermissible intents. The computer-implemented method further comprises rejecting the new user query.

In some embodiments, the virtual avatar is modeled after a live human agent associated with the user.

In some embodiments, the computer-implemented method further comprises receiving, through the agent interface, a request to transfer a communications session from the automated artificial intelligence agent to a live agent. The computer-implemented method further comprises dynamically updating the agent interface to replace the virtual avatar with a new window through which the live agent provides audiovisual communications to the user through the agent interface.

In some embodiments, the response includes an interactive document. The computer-implemented method further comprises updating the text-based messaging window to present the interactive document. The computer-implemented method further comprises receiving user input through the interactive document. The computer-implemented method further comprises processing the user input and interactive document through the response generation LLM to perform one or more operations according to the user inputs.

In some embodiments, the computer-implemented method further comprises monitoring user interactions with the automated artificial intelligence agent to obtain feedback corresponding to the response. The computer-implemented method further comprises updating a dataset of sample user queries and sample responses to add a new data point corresponding to the user query and the response. The new data point is annotated according to the feedback. The computer-implemented method further comprises processing the dataset through the response generation LLM to retrain the response generation LLM.

In some embodiments, the user query is an audial communication provided through selection of one or more user interface elements provided through the agent interface.

In an example, a system comprises one or more processors and memory including instructions that, as a result of being executed by the one or more processors, cause the system to perform the processes described herein. In another example, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Illustrative embodiments are described in detail below with reference to the following figures.

FIG. 1 shows an illustrative example of an environment in which an artificial intelligence agent communication system dynamically implements different artificial intelligence agents configured to automatically communicate with users based on different user requirements in accordance with at least one embodiment;

FIG. 2 shows an illustrative example of an environment in which an artificial intelligence agent communication system is integrated within a client service environment to provide artificial intelligence agents through a client interface in accordance with at least one embodiment;

FIG. 3 shows an illustrative example of an environment in which an artificial intelligence agent dynamically communicates with a user through an agent interface in accordance with at least one embodiment;

FIG. 4 shows an illustrative example of an environment in which an artificial intelligence agent, through an agent avatar window and a messaging window, dynamically responds to user questions in accordance with at least one embodiment;

FIG. 5 shows an illustrative example of an environment in which an artificial intelligence agent, through a messaging window, automatically surfaces an interactive document for a user in response to a user request in accordance with at least one embodiment;

FIG. 6 shows an illustrative example of an environment in which an artificial intelligence agent dynamically transfers a communications session from the artificial intelligence agent to a live agent in response to a user request in accordance with at least one embodiment;

FIG. 7 shows an illustrative example of an environment in which an artificial intelligence agent automatically surfaces, through a messaging window, a set of options corresponding to a user account in accordance with at least one embodiment;

FIG. 8 shows an illustrative example of a process for evaluating a set of embeddings corresponding to a user query according to a set of applicable relevancy rules and known responses to dynamically generate a response to the user query in accordance with at least one embodiment;

FIG. 9 shows an illustrative example of a process for generating and executing a programmatic script to animate and vocalize a virtual agent avatar associated with an artificial intelligence agent based on a newly generated response in accordance with at least one embodiment; and

FIG. 10 shows an illustrative example of an environment in which various embodiments can be implemented.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

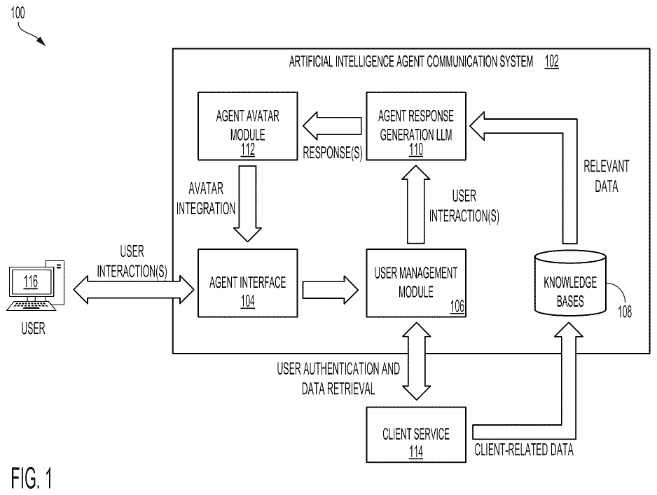

FIG. 1 shows an illustrative example of an environment 100 in which an artificial intelligence agent communication system 102 dynamically implements different artificial intelligence agents configured to automatically communicate with users based on different user requirements in accordance with at least one embodiment. In the environment 100, a user 116 accesses the artificial intelligence agent communication system 102 through an agent interface 104 to request initiation of a new communications session with an artificial intelligence agent dynamically trained and implemented by the artificial intelligence agent communication system 102. In an embodiment, the artificial intelligence agent communication system 102 provides, to users associated with the artificial intelligence agent communication system 102 (such as user 116), an application or web service through which these users may engage in different communications sessions with automated artificial intelligence agents to address different intents expressed by these users. An intent may (for example) be a topic, sentiment, complexity, and/or level of urgency. A topic can include, but is not limited to, a subject, a product, a service, a technical issue, a use question, a complaint, a request, etc.

The artificial intelligence agent communication system 102, in an embodiment, is a system that, for example, processes different user requests through the implementation of automated artificial intelligence agents that are dynamically trained to automatically address user intents. Additionally, the artificial intelligence agent communication system 102, as described in greater detail herein and through different automated processes, may generate customized responses to these user intents according to any applicable constraints (e.g., query relevancy rules, etc.). These customized responses, as described in greater detail herein, may be generated according to known responses maintained by the artificial intelligence agent communication system 102 and/or to different data sources from which the artificial intelligence agent communication system 102 may derive these customized responses according to the corresponding intents.

In an embodiment, the artificial intelligence agent communication system 102 provides an application or web service through which users (such as user 116) may access an agent interface 104 for initiating and engaging in communications sessions with automated artificial intelligence agents to address different user intents. For example, the artificial intelligence agent communication system 102 may provide, to a user 116, an application that may be installed and executed from the user's computing device to access, through the agent interface 104, the artificial intelligence agent communication system 102. Additionally, or alternatively, a user 116, through a browser application installed and executed from the user's computing device, may access a website associated with the artificial intelligence agent communication system 102 and through which the artificial intelligence agent communication system 102 implements a web service that includes the agent interface 104. In some instances, to access the agent interface 104 (either through an application executing on a computing device or through a web service), the user 116 may be required to provide a set of credentials (e.g., username/password, a cryptographic key or token, biometric information, etc.) that may be used to authenticate and identify the user 116. For example, when the user 116 executes the application or accesses the web service to initiate a new communications session through the artificial intelligence agent communication system 102, the artificial intelligence agent communication system 102 may prompt the user 116 to provide a set of credentials associated with the user 116.

In response to receiving the set of credentials associated with the user 116, the artificial intelligence agent communication system 102, through a user management module 106, may process the set of credentials to determine whether the set of credentials is valid. For instance, in response to receiving a set of credentials through the agent interface 104, the user management module 106 may transmit an application programming interface (API) call to a client service 114 to determine whether the provided set of credentials is associated with an existing user account maintained by the client service 114. This API call may be generated by the user management module 106 according to any communications protocols, data structures, and the like associated with an API exposed by the client service 114. Further, the API call may include the set of credentials provided by the user 116 through the agent interface 104. If the client service 114 determines that the provided set of credentials is not associated with an existing user account, or that the provided set of credentials is not valid (e.g., the set of credentials does not match a known set of credentials maintained in an identified user account, the set of credentials is expired, the set of credentials is flagged as being compromised, etc.), the client service 114 may transmit a response to the user management module 106 indicating that the user 116 could not be authenticated. This may cause the user management module 106 to reject the request from the user 116 to initiate a communications session with an automated artificial intelligence agent through the agent interface 104.

If the user 116 is successfully authenticated by the client service 114, the client service 114 may provide any available user account information to the user management module 106. The user management module 106, through the agent interface 104, may provide the user 116 with an indication that the user 116 has been successfully authenticated by the client service 114. Once successfully authenticated, the user 116 may interact with the agent interface 104, such as through submitting user queries or requests to an automated artificial intelligence agent through the agent interface 104.

It should be noted that, in some instances, a user 116 may not be required to provide a set of credentials in order to access the agent interface 104. For example, the artificial intelligence agent communication system 102 may allow a user 116 to access the agent interface 104 and communicate with an artificial intelligence agent with regard to a pre-defined set of intents. However, if the user 116, through the agent interface 104, submits a request to discuss an intent for which user authentication is required in order to enable access to potentially sensitive information (e.g., account-specific information, personally identifiable information (PII), etc.), the artificial intelligence agent, through the agent interface 104, may prompt the user 116 to provide a set of credentials that may be used to authenticate the user 116 and determine whether the user 116 is authorized to access the requested information.

In an embodiment, the agent interface 104 enables the user 116 to transmit communications to an automated artificial intelligence agent through different media. For example, the agent interface 104 may include an input field through which a user 116 may transmit a text-based communication to the automated artificial intelligence agent assigned to the communications session. Additionally, or alternatively, the agent interface 104 may provide one or more user interface elements through which the user 116 may generate and transmit an audial communication to the automated artificial intelligence agent. In an embodiment, as the user 116 transmits a communication to the automated artificial intelligence agent through the agent interface 104, the artificial intelligence agent communication system 102 may automatically update the agent interface 104 to present the communication transmitted by the user 116. For example, if the user 116 submits a text-based communication through an input field of the agent interface 104, the artificial intelligence agent communication system 102 may reproduce this text-based communication through the agent interface 104. As another illustrative example, if the user 116 transmits an audial recording of their communication to the automated artificial intelligence agent, the artificial intelligence agent communication system 102 may process the audial recording using Automatic Speech Recognition (ASR) or other Natural Language Processing (NLP) routine to generate a text-based transcription of the audial recording that may be reproduced and displayed through the agent interface 104.

In an embodiment, user interactions with the agent interface 104 are processed by the user management module 106 and converted into a set of embeddings that are used as input to an agent response generation large language model (LLM) 110. The agent response generation LLM 110 is dynamically trained to generate responses to user queries (e.g., communications submitted through the agent interface 104, etc.) based on evaluation of different data sources available to the agent response generation LLM 110 and of any applicable rules or policies. For example, the agent response generation LLM 110 may maintain a set of knowledge bases 108 or other datastores that are associated with different external and/or internal data sources made available to the artificial intelligence agent communication system 102 for generating responses to any user communications submitted through the agent interface 104. In an embodiment, the agent response generation LLM 110, through this set of knowledge bases 108, maintains different embeddings corresponding to different internal and external data sources made available to the agent response generation LLM 110 for generating responses to received user communications. For instance, the agent response generation LLM 110 may be provided with access to the client service 114 (such as through one or more APIs exposed by the client service 114), which the agent response generation LLM 110 may automatically access or scrape any available data sources within client service 114 and, accordingly, convert the data included in these data sources into different sets of embeddings that may be used to dynamically generate responses to received user communications. The agent response generation LLM 110 may be granted access to a significant number of internal and/or external data sources (e.g., private/organization-based data sources, publicly available data sources, etc.) such that the set of knowledge bases 108 maintained by the agent response generation LLM 110 may include different embeddings corresponding to millions or billions of different data sources. Thus, the agent response generation LLM 110, in some embodiments, is implemented using thousands, tens of thousands, or more processors that are configured to operate in parallel to access any available data sources and generate corresponding embeddings.

The agent response generation LLM 110 is, in an embodiment, dynamically trained using a dataset comprising a large corpus of sample communications (e.g., historical communications corresponding to different communications sessions between users and automated artificial intelligence agents, hypothetical communications, combinations of historical and hypothetical communications, etc.), sample embeddings corresponding to the sample communications, and sample responses to the sample communications (e.g., historical responses, hypothetical responses, combinations of historical and hypothetical responses, etc.). The agent response generation LLM 110 may be initialized with a first set of values corresponding to different hyperparameters or other coefficients that, in combination, are used to derive an output given a sample input (e.g., sample communications). For instance, the agent response generation LLM 110 may be initialized using a random set of coefficients or other hyperparameters defined according to a Gaussian distribution or through other distribution methods. The dataset of sample communications may be processed using this initial iteration of the agent response generation LLM 110 to generate an output. This output may specify, for each sample communication, a response to the communication. The agent response generation LLM 110 may compare the output (e.g., predicted responses) to the expected responses included in the dataset. Based on this comparison, the agent response generation LLM 110 may dynamically update one or more values corresponding to the different hyperparameters or other coefficients and again process the dataset to generate new outputs. This process may be repeated numerous times until an iteration of the agent response generation LLM 110 is obtained that satisfies one or more accuracy or predictability thresholds.

The agent response generation LLM 110, in an embodiment, is further trained in conjunction with Retrieval-Augmented Generation (RAG) to improve the accuracy and predictability of responses to different intents expressed through the agent interface 104. For example, the agent response generation LLM 110 may be evaluated according to different linguistic metrics (e.g., Bilingual Evaluation Understudy (BLEU) scores, language fluency metrics, semantic consistency metrics, etc.) to determine whether the predicted responses are likely to be understood by a human user, such as user 116. If the agent response generation LLM 110 fails to produce responses that satisfy one or more linguistic metric thresholds, one or more values corresponding to the different hyperparameters or other coefficients of the agent response generation LLM 110 may be updated and the dataset may be processed through the updated agent response generation LLM 110 to generate new responses that may be evaluated according to the different linguistic metrics until an iteration of the agent response generation LLM 110 is generated that satisfies the linguistic metric thresholds. Further, the agent response generation LLM 110 may be evaluated to determine whether the agent response generation LLM 110 is accurately leveraging the set of knowledge bases 108 to generate responses that address the intents associated with the sample communications in the dataset. This may include an evaluation of the agent response generation LLM 110 to determine whether the agent response generation LLM 110 is accurately converting the sample communications in the dataset into the expected set of embeddings and identifying the correct data sources from the set of knowledge bases 108 according to this set of embeddings. Based on this evaluation, the agent response generation LLM 110 may be updated to further improve the responses generated by the agent response generation LLM 110.

In an embodiment, the artificial intelligence agent communication system 102 maintains, within the set of knowledge bases 108, a set of relevancy rules that may be used to determine whether a user communication submitted through the agent interface 104 is relevant to the intents that the artificial intelligence agent communication system 102 is implemented to resolve. For example, the set of relevancy rules may include a set of embeddings corresponding to impermissible intents that may not be addressed by the artificial intelligence agent communication system 102. If the agent response generation LLM 110, through processing of a user communication, determines that the set of embeddings corresponding to this user communication match or otherwise satisfy a match predictability threshold (e.g., the embeddings are ≥85% match, etc.) with a set of embeddings corresponding to an impermissible intent, the agent response generation LLM 110 may determine that the user 116 has submitted an irrelevant communication that cannot be addressed by the artificial intelligence agent communication system 102.

In response to a determination that the user 116 has communicated an impermissible intent, the automated artificial intelligence agent may reject the communication as being irrelevant to the purpose of the artificial intelligence agent communication system 102. In some instances, the automated artificial intelligence agent may perform one or more remedial actions as a result of the user 116 having communicated an impermissible intent. For instance, the automated artificial intelligence agent may automatically generate a response that admonishes the user 116 for submitting an impermissible communication through the agent interface 104. In some instances, the automated artificial intelligence agent may automatically terminate the communication session in response to the impermissible communication. In some instances, the user management module 106 may restrict user access to the artificial intelligence agent communication system 102 in response to an impermissible communication. For example, the user management module 106 may add one or more restrictions to the user's account within the client service 114 to prevent the user from accessing the artificial intelligence agent communication system 102 for a period of time (e.g., one day, one week, one month, etc.). Further, these one or more restrictions may be defined according to the severity of the user's violation of any applicable rules. In some instances, the restrictions that are applied in response to an impermissible communication may be defined in conjunction with the set of embeddings corresponding to impermissible intents in the set of knowledge bases 108.

The filtering of impermissible communications through the agent response generation LLM 110 may provide various computational benefits to the functioning of the artificial intelligence agent communication system 102. For instance, because the agent response generation LLM 110 is trained to automatically reject any user communications that do not comport with any applicable rules, the artificial intelligence agent communication system 102 does not have to process these user communications further, thereby reducing the processing requirements of the artificial intelligence agent communication system 102 in identifying any internal and/or external data sources for generating responses to these impermissible user communications. Further, the agent response generation LLM 110 increases the network security of the artificial intelligence agent communication system 102 by automatically rejecting any communications that are not associated with permissible intents, preventing generation of responses that may include sensitive data or other data that the corresponding user may not be authorized to obtain.

If the communication from the user 116 corresponds to a permissible intent and the agent response generation LLM 110 leverages the set of knowledge bases 108 to generate a response to the communication, the agent response generation LLM 110 may transmit this response to an agent avatar module 112 for presentation to the user 116 through the agent interface 104. In an embodiment, the agent avatar module 112 automatically implements a virtual avatar that may graphically represent the automated artificial intelligence agent through the agent interface 104. This virtual avatar may be configured to emulate the appearance of a human and may be animated to mimic human speech when providing audial responses through the agent interface 104. For example, the face (e.g., lips, mouth, eyes, etc.) and body of the virtual avatar graphically represented through the agent interface 104 may move in unison with the audial responses generated through the agent avatar module 112 to mimic actual human interaction.

In an embodiment, the graphical representation of the virtual avatar represented through the agent interface 104 is modeled after an actual live agent associated with the user 116. For instance, if the user 116 previously engaged a live agent with regard to a user account, the graphical representation of the virtual avatar may be modeled after this live agent so that the user 116, through the agent interface 104, may communicate with a graphical facsimile of the known live agent. In some instances, if the user 116 is assigned to a new live agent, the artificial intelligence agent communication system 102, through the agent avatar module 112 and the agent interface 104, may provide a new virtual avatar corresponding to the new live agent. Further, if the user 116 is transferred from a first live agent to a second live agent during a communications session, the artificial intelligence agent communication system 102, through the agent avatar module 112, may dynamically update the agent interface 104 to replace a virtual avatar of the first live agent with a new virtual avatar of the second live agent. In some instances, the virtual avatar represented in the agent interface 104 may correspond to a generic or stock human model and may not represent an actual live agent. This may provide the user 116 with a consistent virtual avatar even if a user account is transferred from one live agent to another live agent while a corresponding user account is active.

In an embodiment, in response to a new response generated by the agent response generation LLM 110, the agent avatar module 112 may generate a programmatic script according to the new response. This programmatic script may define configurable frame start/stop times, speed, looping, delays, durations, randomizing of animations, partial animations, and expression freezing for the virtual avatar. The agent avatar module 112 may define this script using any programmatic code (e.g., JavaScript, etc.) that is executable by the automated artificial intelligence agent to render and display the avatar animation through the agent interface 104. Through execution of this script, the virtual avatar may be animated to appear as though the avatar is vocalizing the response generated by the agent response generation LLM 110. Further, the virtual avatar may be animated such that the vocalization of the response through the virtual avatar has a natural cadence and appearance to the user 116. Further, execution of the script may cause the automated artificial intelligence agent to produce an audial communication of the response that is synchronized to the virtual avatar animations.

In an embodiment, as the user 116 interacts with the automated artificial intelligence agent through the agent interface 104 (e.g., responds to any communicated agent responses, submits new communications, etc.), the user management module 106 may process these interactions through the agent response generation LLM 110 to generate new responses and to obtain feedback corresponding to the previously communicated agent responses. This feedback may be used to dynamically retrain the agent response generation LLM 110. For instance, if the user 116 expresses, in response to a communication generated by the agent response generation LLM 110 and communicated through the agent interface 104, confusion or lack of understanding of the agent communication, this may serve as an indication that the agent communication was not positively received by the user 116. Accordingly, the agent communication and the corresponding user query previously submitted by the user 116 may be annotated to include this negative feedback, as well as any actions to be taken to address the negative feedback (e.g., indication of areas for improvement of the agent communication, corrections to the agent communication, expected responses to the user query, etc.). These annotations may be added to the training dataset and used to dynamically retrain or otherwise update the agent response generation LLM 110.

It should be noted that the artificial intelligence agent communication system 102, through the aforementioned agent response generation LLM 110, can continuously and simultaneously process different user communications corresponding to different communications sessions and generate responses to these different user communications and messages. For instance, as different user communications associated with different users are received, the artificial intelligence agent communication system 102, through the agent response generation LLM 110, may continuously process these different user communications in real-time or near real-time to extract the corresponding intents and, based on these intents and available data from corresponding user accounts and from the set of knowledge bases 108, generate relevant responses that may be provided to these different users. Further, these responses may be used to animate different virtual avatars corresponding to the different automated artificial intelligence agents implemented for each of these different communications sessions. As communications are exchanged through these different communications sessions, the user management module 106 may obtain feedback corresponding to these different communications and may continually update the training dataset for the agent response generation LLM 110. This continually updated dataset may be used to continuously retrain and update the agent response generation LLM 110.

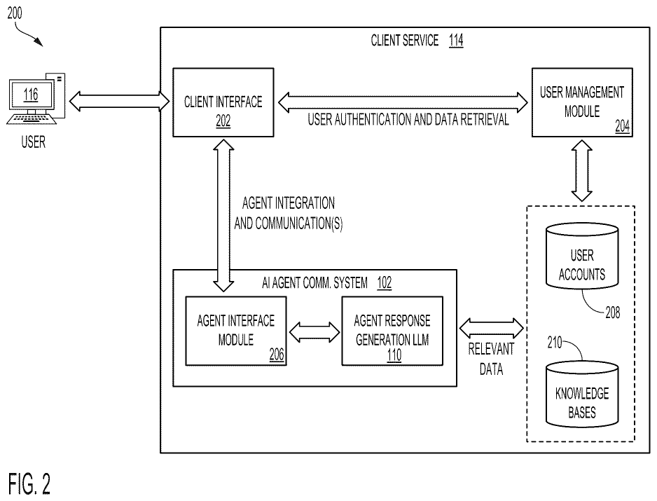

FIG. 2 shows an illustrative example of an environment 200 in which an artificial intelligence agent communication system 102 is integrated within a client service environment to provide artificial intelligence agents through a client interface 202 in accordance with at least one embodiment. In the environment 200, a client service 114 may implement the artificial intelligence agent communication system 102 and its corresponding functionality natively. Thus, as illustrated in FIG. 2, the artificial intelligence agent communication system 102 may not be a standalone system and may be integrated into one or more computing systems associated with the client service 114.

As illustrated in FIG. 2, the client service 114 may implement a client interface 202 through which a user 116 can access the client service 114 to request initiation of a new communications session with an artificial intelligence agent dynamically trained and implemented by the artificial intelligence agent communication system 102. In this particular example, the client service 114 may provide an application or web service through which users (such as user 116) may access the client interface 202 to initiate and engage in communications sessions with automated artificial intelligence agents to address different user intents, as well as interact with any other functions provided by the client service 114. For example, the client service 114 may provide, to a user 116, an application that may be installed and executed from the user's computing device to access, through the client interface 202, the client service 114. Additionally, or alternatively, a user 116, through a browser application installed and executed from the user's computing device, may access a website associated with the client service 114 and through which the client service 114 implements a web service that includes the client interface 202. In some instances, to access the client interface 202 (either through an application executing on a computing device or through a web service), the user 116 may be required to provide a set of credentials (e.g., username/password, a cryptographic key or token, biometric information, etc.) that may be used to authenticate and identify the user 116. For example, when the user 116 executes the application or accesses the web service to initiate a new communications session through the client interface 202, the client service 114 may prompt the user 116 to provide a set of credentials associated with the user 116.

In response to receiving the set of credentials associated with the user 116, the client service 114, through a user management module 204, may process the set of credentials to determine whether the set of credentials is valid. For instance, in response to receiving a set of credentials through the client interface 202, the user management module 204 may query a user accounts datastore 208 to determine whether the provided set of credentials is associated with an existing user account maintained by the client service 114. If the client service 114 determines that the provided set of credentials is not associated with an existing user account, or that the provided set of credentials is not valid (e.g., the set of credentials does not match a known set of credentials maintained in an identified user account, the set of credentials is expired, the set of credentials is flagged as being compromised, etc.), the user management module 204, through the client interface 202, may indicate that the user 116 could not be authenticated. If the user 116 is successfully authenticated by the client service 114, the client service 114 may provide any available user account information to the artificial intelligence agent communication system 102 for use in generating responses to user queries and communications. Further, the user management module 204, through the client interface 202, may provide the user 116 with an indication that the user 116 has been successfully authenticated by the client service 114.

Once the user 116 is successfully authenticated by the client service 114, the client service 114 may update the client interface 202 to incorporate agent interface elements similar to those of the agent interface 104 described above in connection with FIG. 1. For instance, the client interface 202 may be updated to incorporate a virtual avatar window through which a virtual avatar of the automated artificial intelligence agent may be presented. Further, the client interface 202 may be updated to include a communication window through which the user 116 and the automated artificial intelligence agent may exchange communications. In an embodiment, the client interface 202, through the aforementioned agent interface elements, enables the user 116 to transmit communications to an automated artificial intelligence agent through different media. For example, the agent interface elements may include an input field through which the user 116 may transmit a text-based communication to the automated artificial intelligence agent assigned to the communications session. Additionally, or alternatively, the agent interface elements provided through the client interface 202 may include one or more user interface elements through which the user 116 may generate and transmit an audial communication to the automated artificial intelligence agent.

In an embodiment, as the user 116 transmits a communication to the automated artificial intelligence agent through the agent interface 104, the artificial intelligence agent communication system 102 may automatically update the client interface 202 to present the communication transmitted by the user 116. For example, if the user 116 submits a text-based communication through an input field of the client interface 202, the artificial intelligence agent communication system 102 may reproduce this text-based communication through the client interface 202. As another illustrative example, if the user 116 transmits an audial recording of their communication to the automated artificial intelligence agent, the artificial intelligence agent communication system 102 may process the audial recording using ASR or other NLP routine to generate a text-based transcription of the audial recording that may be reproduced and displayed through the client interface 202.

In an embodiment, user interactions with the different agent interface elements provided through the client interface 202 are processed by an agent interface module 206 implemented by the artificial intelligence agent communication system 102 and converted into a set of embeddings that are used as input to the agent response generation LLM 110. As noted above, the agent response generation LLM 110 is dynamically trained to generate responses to user queries based on evaluation of different data sources available to the agent response generation LLM 110 and of any applicable rules or policies. However, in the environment 200, the agent response generation LLM 110 may leverage a set of knowledge bases 210 and the user accounts datastore 208 maintained by the client service 114 as opposed to internally maintained knowledge bases, such as the set of knowledge bases 108 described above in connection with FIG. 1. The set of knowledge bases 210 maintained by the client service 114 is associated with different external and/or internal data sources made available to the client service 114 and that may be leveraged by the artificial intelligence agent communication system 102 to generate responses to any user communications. Similar to the set of knowledge bases 108, the agent response generation LLM 110, through this set of knowledge bases 210, may maintain different embeddings corresponding to different internal and external data sources made available to the agent response generation LLM 110 for generating responses to received user communications.

In an embodiment, the client service 114 maintains, within the set of knowledge bases 210, a set of relevancy rules that may be used to determine whether a user communication submitted through the client interface 202 is relevant to the intents that the artificial intelligence agent communication system 102 is implemented to resolve. Returning to an earlier illustrative example, the set of relevancy rules may include a set of embeddings corresponding to impermissible intents that may not be addressed by the artificial intelligence agent communication system 102. If the agent response generation LLM 110, through processing of a user communication, determines that the set of embeddings corresponding to this user communication match or otherwise satisfy a match predictability threshold (e.g., the embeddings are a ≥85% match with an impermissible intent, etc.) with a set of embeddings corresponding to an impermissible intent, the agent response generation LLM 110 may determine that the user 116 has submitted an irrelevant communication that cannot be addressed by the artificial intelligence agent communication system 102.

In response to a determination that the user 116 has communicated an impermissible intent, the automated artificial intelligence agent may reject the communication as being irrelevant to the purpose of the artificial intelligence agent communication system 102. In some instances, the automated artificial intelligence agent may perform one or more remedial actions as a result of the user 116 having communicated an impermissible intent. For instance, the automated artificial intelligence agent may automatically generate a response that admonishes the user 116 for submitting an impermissible communication through the client interface 202. In some instances, the automated artificial intelligence agent may automatically terminate the communication session in response to the impermissible communication. In some instances, the user management module 204 may restrict user access to the client interface 202 in response to an impermissible communication. For example, the user management module 204 may update the user accounts datastore 208 to add one or more restrictions to the user's account to prevent the user from accessing the client interface 202 for a period of time (e.g., one day, one week, one month, etc.). Further, these one or more restrictions may be defined according to the severity of the user's violation of any applicable rules. In some instances, the restrictions that are applied in response to an impermissible communication may be defined in conjunction with the set of embeddings corresponding to impermissible intents in the set of knowledge bases 210.

If the communication from the user 116 corresponds to a permissible intent and the agent response generation LLM 110 leverages the set of knowledge bases 210 and the user accounts datastore 208 to generate a response to the communication, the agent response generation LLM 110 may transmit this response to the agent interface module 206 for presentation to the user 116 through the client interface 202. Similar to the agent avatar module 112 described above in connection with FIG. 1, the agent interface module 206 may automatically implement a virtual avatar that may graphically represent the automated artificial intelligence agent through the client interface 202. In response to a new response generated by the agent response generation LLM 110, the agent interface module 206 may generate a programmatic script according to the new response. This programmatic script may define configurable frame start/stop times, speed, looping, delays, durations, randomizing of animations, partial animations, and expression freezing for the virtual avatar. Through execution of this script, the virtual avatar may be animated to appear as though the avatar is vocalizing the response generated by the agent response generation LLM 110. Further, the virtual avatar may be animated such that the vocalization of the response through the virtual avatar has a natural cadence and appearance to the user 116. Further, execution of the script may cause the automated artificial intelligence agent to produce an audial communication of the response that is synchronized to the virtual avatar animations.

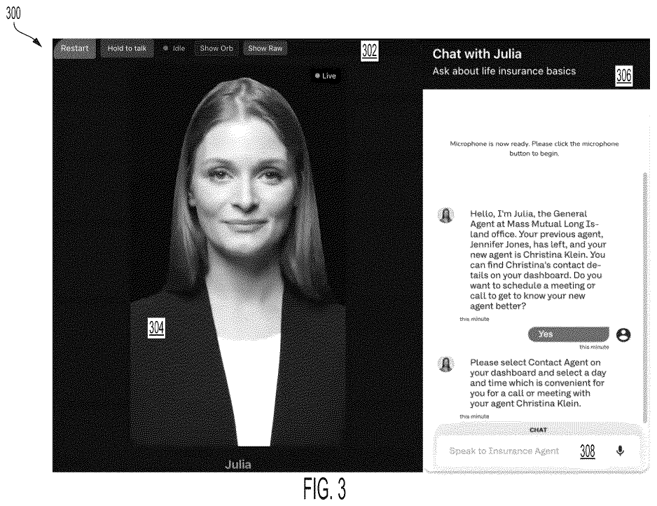

FIG. 3 shows an illustrative example of an environment 300 in which an artificial intelligence agent dynamically communicates with a user through an agent interface 302 in accordance with at least one embodiment. In the environment 100, a user may access the agent interface 302 through a web portal provided by the artificial intelligence agent communication system or a client service, or through an application implemented by the artificial intelligence agent communication system or a client service and executed on a user device (e.g., smartphone, tablet, personal computer, etc.).

The agent interface 302, as illustrated in FIG. 3, may include a virtual agent avatar window 304 and a messaging window 306 through which an automated artificial intelligence agent may dynamically communicate with a user via audial-and text-based communications. The virtual agent avatar window 304, in an embodiment, includes a personalized graphical representation of the virtual agent avatar. The graphical representation of the virtual agent avatar may have the appearance of a human and may be animated to mimic human speech when providing audial-based communications. For example, the movement of the face (e.g., lips, mouth, eyes, etc.) and body of the virtual agent avatar graphically represented in the virtual agent avatar window 304 may be synchronized with the audial-based communications generated by the automated artificial intelligence agent to mimic actual human interaction.

As noted above, the virtual agent avatar represented in the virtual agent avatar window 304 is modeled after an actual live agent associated with the user. For instance, if the user previously engaged a live agent with regard to a user account, the virtual agent avatar may be modeled after this live agent so that the user, through the agent interface 302, may communicate with a graphical facsimile of the known live agent. In some instances, if the user is assigned to a new live agent, the artificial intelligence agent communication system, through the virtual agent avatar window 304, may provide a new virtual avatar corresponding to the new live agent. Further, if the user is transferred from a first live agent to a second live agent during a communications session, the artificial intelligence agent communication system may dynamically update the virtual agent avatar window 304 to replace the virtual avatar of the first live agent with a new virtual avatar of the second live agent.

In some instances, the virtual agent avatar represented in the virtual agent avatar window 304 may correspond to a generic or stock human model and may not represent an actual live agent. This may provide the user with a consistent virtual agent avatar even if a user account is transferred from one live agent to another live agent while a corresponding user account is active. For example, as illustrated in FIG. 3, the virtual agent avatar presented through the virtual agent avatar window 304 may correspond to a “general agent” that communicates with all users associated with a particular client. This “general agent” may not correspond to an actual live agent associated with the user but may instead correspond to a specialized automated artificial intelligence agent implemented by the artificial intelligence agent communication system.

As illustrated in FIG. 3, the agent interface 302 may further include a messaging window 306 through which the automated artificial intelligence agent may exchange text-based messages with the user. The automated artificial intelligence agent, in an embodiment, is implemented through the aforementioned agent response generation LLM that is dynamically trained to generate responses to user queries (e.g., communications or messages exchanged through the messaging window 306) based on evaluation of myriad knowledge base articles and other data sources associated with an underlying client. The messaging window 306, as illustrated in FIG. 3, may include an input field 308 through which a user may transmit a message or other communication to the automated artificial intelligence agent. Any message or communication submitted through the input field 308 may be presented through the messaging window 306 in conjunction with any previously exchanged messages or other communications.

The artificial intelligence agent communication system, through the aforementioned agent response generation LLM, may compare the set of embeddings corresponding to a user message or communication transmitted through the input field 308 against the different sets of embeddings corresponding to the myriad knowledge base articles and other data sources associated with the underlying client to identify an appropriate knowledge base article or other data source that may be used to derive a response to the user message or communication. For example, as illustrated in FIG. 3, the user has indicated that they would like to schedule a meeting or call to get to know their new live agent. The agent response generation LLM may translate this user indication into a set of embeddings that are subsequently used by the agent response generation LLM to identify a known response to such indications. This known response may include an instruction to select the “Contact Agent” option from the user's dashboard and to select an appropriate day and time for a call with their new live agent. Accordingly, the automated artificial intelligence agent may obtain this known response from the agent response generation LLM and surface the known response to the user through the messaging window 306. As noted above, when the automated artificial intelligence agent provides a text-based response to the user through the messaging window 306, the automated artificial intelligence agent may produce a voice-based communication corresponding to the response and execute a programmatic script to animate the virtual agent avatar presented in the virtual agent avatar window 304 to mimic a human expressing the audial-based communication.

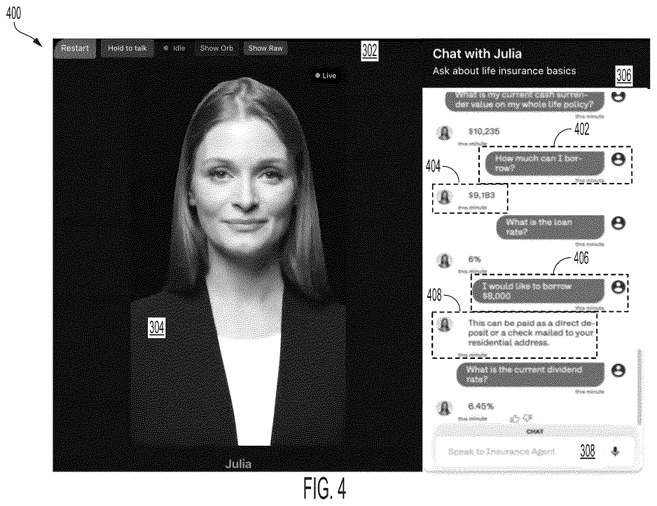

FIG. 4 shows an illustrative example of an environment 400 in which an artificial intelligence agent, through an agent avatar window 304 and a messaging window 306, dynamically responds to user questions in accordance with at least one embodiment. In the environment 400, the user may submit a query 402 to the automated artificial intelligence agent through the input field 308 of the messaging window 306. In response to the user query 402, the automated artificial intelligence agent may process the user query 402 through the agent response generation LLM to generate a set of embeddings. In this illustrative example, the user query 402 may correspond to information that may derived from the user's account. Accordingly, the agent response generation LLM may use the set of embeddings corresponding to the user query 402 to determine that an evaluation of the user's account is required to derive the appropriate response. The agent response generation LLM may provide the response to the automated artificial intelligence agent, which may present a text-based version of the response (e.g., response 404) to the user through the messaging window 306. Further, the automated artificial intelligence agent may produce a audial-based communication corresponding to the response 404 and, through execution of a programmatic script generated by the agent avatar module according to the response generated by the agent response generation LLM, animate the virtual agent avatar presented in the virtual agent avatar window 304 to mimic a human expressing the audial-based communication.

The user, through the input field 308 of the messaging window 306, may further submit a request 406 that may be fulfilled by the automated artificial intelligence agent. For instance, as illustrated in FIG. 4, the user may submit a request 406 to borrow $8,000 against their existing policy. The automated artificial intelligence agent may process the request 406 through the agent response generation LLM to generate a set of embeddings that may be processed according to known embeddings from the set of knowledge bases to derive an appropriate response. For instance, the agent response generation LLM may determine, based on the set of embeddings, that an evaluation of the user's account and corresponding policy are required to determine whether the request 406 may be fulfilled. Further, if the request 406 may be fulfilled, the agent response generation LLM may further generate a response 408 that provides the user with different options for resolution of the request 406. For example, through the response 408, the user may be provided with options to either direct deposit the loaned amount or to have a check mailed to the user for the loaned amount. The user, through the input field 308, may provide a response indicating which option they would prefer. Similar to the response 404, the agent response generation LLM may provide the response to the automated artificial intelligence agent, which may present a text-based version of the response (e.g., response 408) to the user through the messaging window 306. Further, the agent response generation LLM, through the agent avatar module, may generate a programmatic script that, when executed by the automated artificial intelligence agent, causes the automated artificial intelligence agent to produce an audial-based communication corresponding to the response 408 and to animate the virtual agent avatar presented in the virtual agent avatar window 304 to mimic a human expressing the audial-based communication. It should be noted that the aforementioned example is provided for illustrative purposes and the automated artificial intelligence agent may process myriad requests corresponding to different contexts through the agent response generation LLM to generate appropriate responses.

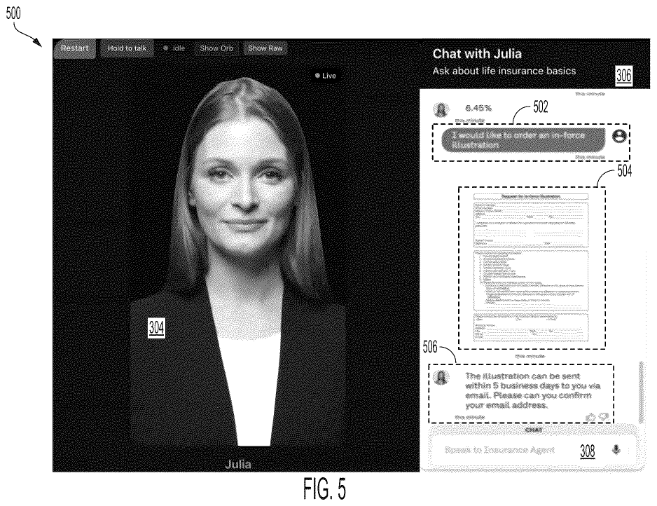

FIG. 5 shows an illustrative example of an environment 500 in which an artificial intelligence agent, through a messaging window 306, automatically surfaces an interactive document 504 for a user in response to a user request 502 in accordance with at least one embodiment. In the environment 500, through the input field 308 of the messaging window 306, may submit a request 502 for a document that may be provided by the automated artificial intelligence agent. In response to the request 502, the automated artificial intelligence agent may process the request 502 through the agent response generation LLM to generate a set of embeddings that may be evaluated against different embeddings from the set of knowledge bases maintained by the artificial intelligence agent communication system to derive an appropriate response. In this instance, the agent response generation LLM may determine, based on the set of embeddings corresponding to the request 502, that the user is to be provided with an interactive document 504 and a corresponding response 506 with instructions on how to utilize the interactive document 504.

The agent response generation LLM may provide, through the agent avatar module, the interactive document 504 and the response to the automated artificial intelligence agent, which may present the interactive document 504 and a text-based version of the response (e.g., response 506) to the user through the messaging window 306. Through the messaging window 306, the user may access the interactive document 504 and provide any required inputs through the interactive document 504. Through the messaging window 306, the user may provide a completed interactive document 504, which may be processed by the agent response generation LLM to perform additional operations according to the inputs provided through the interactive document 504.

The text-based response 506 may further provide the user with instructions for using the interactive document 504. For example, as illustrated in FIG. 5, through the text-based response 506, the automated artificial intelligence agent may inform the user that a copy of the interactive document 504 is to be sent to the user through their personal electronic mail address. Further, the automated artificial intelligence agent may instruct the user to confirm their personal electronic mail address for delivery of the interactive document 504. If the user, through the input field 308, provides their electronic mail address, the automated artificial intelligence agent, through the agent response generation LLM, may process the provided electronic mail address and transmit the interactive document 504 to the user. As with the previous examples, the automated artificial intelligence agent may produce an audial-based communication corresponding to the response 506 and execute a programmatic script provided by the agent avatar module to animate the virtual agent avatar presented in the virtual agent avatar window 304 to mimic a human expressing a corresponding audial-based communication.

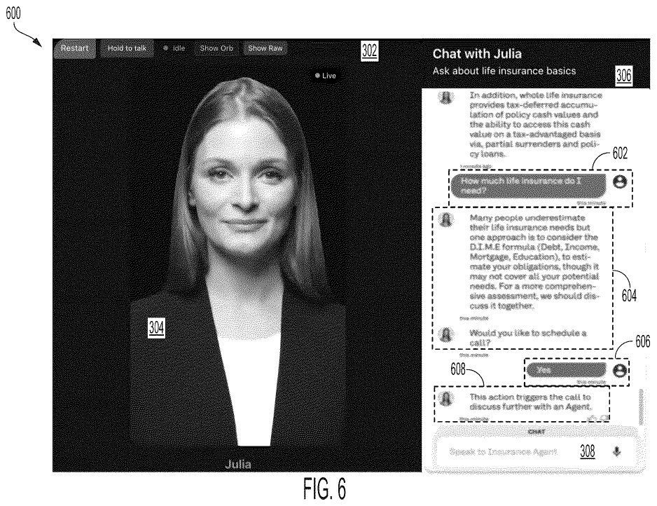

FIG. 6 shows an illustrative example of an environment 600 in which an artificial intelligence agent dynamically transfers a communications session from the artificial intelligence agent to a live agent in response to a user request in accordance with at least one embodiment. In the environment 600, the user, through the input field 308, may submit a user query 602 corresponding to an amount of life insurance that the user might need. Similar to the previous examples above, the automated artificial intelligence agent may process the user query 602 through the agent response generation LLM to generate a set of embeddings that may be processed according to the embeddings corresponding to different knowledge base articles and other data sources maintained in the set of knowledge bases to derive an appropriate response. In this instance, the agent response generation LLM may process the set of embeddings and identify a knowledge base article that provides a known response to the user query 602. This knowledge base article may be provided by the client and may include a known response prepared by the client. Accordingly, the agent response generation LLM may provide the known response to the automated artificial intelligence agent through the agent avatar module.

The automated artificial intelligence agent, through the messaging window 306 of the agent interface 302, may provide a text-based response 604 that includes the known response. In some instances, if the known response includes an indication that further actions may be required to address the user query 602, the automated artificial intelligence agent, through the text-based response 604, may prompt the user to determine whether they would like to execute these further actions. For example, as illustrated in FIG. 6, the known response may include an indication that a further comprehensive assessment may be required and that the user should contact their live agent for this comprehensive assessment. Thus, the automated artificial intelligence agent, through the text-based response 604, may prompt the user to determine whether they would like to schedule a call with their live agent.

In response to the text-based response 604, the user may submit a new response 606 indicating if they would like to contact their live agent according to the known response provided to the user. If the user has indicated, through the new response 606, that they wish to communicate with their live agent to address the elements of the known response (e.g., conducting the comprehensive assessment of their needs), the automated artificial intelligence agent may provide, through the messaging window 306, an indication 608 that the communications session with the automated artificial intelligence agent is being transferred to the live agent. Accordingly, the live agent may communicate with the user through the messaging window 306 to perform any corresponding actions as indicated in the known response. In an embodiment, if the communications session is transferred from the automated artificial intelligence agent to a live agent, the agent interface 302 may be updated by replacing the virtual agent avatar window 304 with a new window through which the live agent may provide audiovisual communications to the user through the agent interface 302. In some instances, the virtual agent avatar window 304 may be maintained and the virtual agent avatar may be replaced with a new graphical representation of the live agent that may be animated according to any text-based communications provided by the live agent through the messaging window 306.

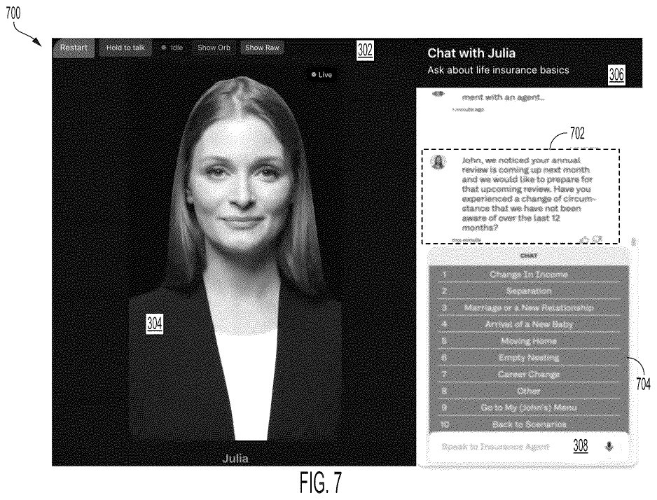

FIG. 7 shows an illustrative example of an environment 700 in which an artificial intelligence agent automatically surfaces, through a messaging window 306, a set of options 704 corresponding to a user account in accordance with at least one embodiment. In the environment 700, when a user accesses the agent interface 302, the automated artificial intelligence agent may automatically evaluate a corresponding user account to detect any milestones or other triggering events that may require further user action. For example, as illustrated in FIG. 7, the automated artificial intelligence agent, through the agent response generation LLM, may evaluate the user account (such as through an API call to the client service that maintains the user account, etc.) to determine that the user has an upcoming annual review for which some preparation may be required. Accordingly, the agent response generation LLM may dynamically generate a message that provides the user with an indication of this upcoming annual review and further includes a prompt to the user to provide an indication of any changes in circumstances that have occurred over the previous year. This message may be communicated by the automated artificial intelligence agent through a text-based message 702 in the messaging window 306 and through a corresponding audial-based communication provided through the virtual agent avatar in the virtual agent avatar window 304.

Based on the particular prompt being provided to the user, the agent response generation LLM may further generate a set of options 704 that may be presented to the user to assist the user in providing a response to the particular prompt. Returning to the illustrative example provided in FIG. 7, the agent response generation LLM, through the automated artificial intelligence agent, may provide the user with various options 704 corresponding to possible changes of circumstance associated with the user over the past year and for which information may be required in order to prepare for the upcoming annual review. The user, through the messaging window 306, may select any of the set of options 704 provided, which may cause the agent response generation LLM to surface additional prompts for information that the user may supply through the input field 308, interactive documents, or other techniques.

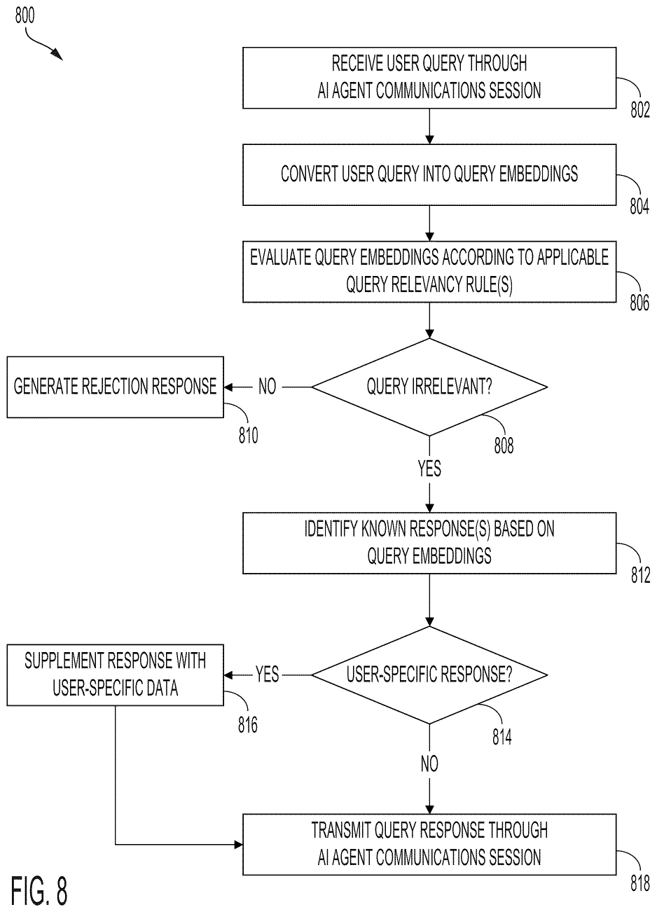

FIG. 8 shows an illustrative example of a process 800 for evaluating a set of embeddings corresponding to a user query according to a set of applicable relevancy rules and known responses to dynamically generate a response to the user query in accordance with at least one embodiment. The process 800 may be performed by the artificial intelligence agent communication system, through the agent response generation LLM described above.

At step 802, the artificial intelligence agent communication system may receive a user query through an artificial intelligence agent communications session between a user and an artificial intelligence agent. As noted above, the artificial intelligence agent communication system may provide an application or web service through which users may access an agent interface. Through this agent interface, a user may engage in a communications session with an automated artificial intelligence agent. For instance, the artificial intelligence agent communication system may provide, through the agent interface, an input field through which the user may submit text-based communications to the automated artificial intelligence agent. Additionally, the artificial intelligence agent communication system may provide, through the agent interface, one or more options (such as through different user interface elements) to record and submit a user query in the form of an audial communication to the automated artificial intelligence agent.

At step 804, the artificial intelligence agent communication system may convert the obtained user query into a set of query embeddings. For instance, the artificial intelligence agent communication system, through a user management module, may process the user query to convert this user query into a set of query embeddings that may be processed to identify an appropriate response to the user query. In an embodiment, the user management module implements a NLP system that is dynamically trained to process user queries obtained through the agent interface to convert these user queries into sets of query embeddings. The NLP system may be dynamically trained using a dataset of sample user queries (e.g., historical user queries, hypothetical user queries, combinations of historical and hypothetical user queries, etc.) and sample query embeddings corresponding to these sample user queries.

In an embodiment, the user management module trains the NLP system by generating an initial iteration of the NLP system through defining an initial set of coefficients or hyperparameters randomly according to one or more distribution methods (e.g., Gaussian distribution, non-Gaussian distribution, etc.). Using this initial iteration of the NLP system, the user management module may process the dataset of sample user queries and corresponding sample query embeddings to generate an output. This output may specify, for each sample user query included in the dataset, a predicted set of query embeddings. The user management module may compare the predicted set of query embeddings generated using the initial iteration of the NLP system to the sample query embeddings defined in the training dataset for each of the data points (e.g., sample user queries) to identify any inaccuracies or other errors.

If the output of the NLP system does not satisfy one or more criteria, the user management module may iteratively update one or more coefficients or hyperparameters of the NLP system to generate a new iteration of the NLP system. The user management module may process the training dataset (including any additional data points or other datasets obtained by the artificial intelligence agent communication system) through new iteration of the NLP system to generate a new output for each data point in the training dataset. In some instances, the user management module may use an optimization algorithm to iteratively update the one or more coefficients or hyperparameters associated with the NLP system. The user management module may use this new iteration of the NLP system to process the available data points within the training dataset and generate a new output. The user management module may evaluate this new output to determine whether the output satisfies the one or more criteria. This process of updating the set of coefficients or hyperparameters associated with the NLP system according to the one or more criteria may be performed iteratively until an iteration of the NLP system is produced that satisfies the one or more criteria.

At step 806, the artificial intelligence agent communication system, through the agent response generation LLM, may evaluate the set of query embeddings corresponding to the submitted user query according to any applicable query relevancy rules. As noted above, the artificial intelligence agent communication system maintains, within a set of knowledge bases, a set of relevancy rules that may be used to determine whether a user communication submitted through the agent interface is relevant to the intents that the artificial intelligence agent communication system is implemented to resolve. Returning to an earlier illustrative example, the set of relevancy rules may include a set of relevancy embeddings corresponding to impermissible intents that may not be addressed by the artificial intelligence agent communication system. The agent response generation LLM may evaluate the query embeddings against these relevancy embeddings. This evaluation may be performed according to a set of vectors of similarity, whereby different dimensional values (e.g., embeddings) corresponding to the user query may be compared to the dimensional values corresponding to the set of relevancy rules defined by the artificial intelligence agent communication system.

At step 808, the artificial intelligence agent communication system, through the agent response generation LLM, determines whether the user query is irrelevant to the purpose of the artificial intelligence agent communication system. If the agent response generation LLM, through processing of the set of query embeddings, determines that the set of query embeddings corresponding to this user communication match or otherwise satisfy a match predictability threshold (e.g., the embeddings are a ≥85% match, etc.) with a set of relevancy embeddings corresponding to an impermissible intent, the agent response generation LLM may determine that the user has submitted an irrelevant communication that cannot be addressed by the artificial intelligence agent communication system. It should be noted that the match predictability threshold may be defined according to any matching level value, as determined by the artificial intelligence agent communication system or other entity associated with the artificial intelligence agent communication system.

In response to a determination that the user query corresponds to an impermissible intent, the automated artificial intelligence agent system, at step 810, may generate a rejection response. For example, the automated artificial intelligence agent system may automatically generate a response that admonishes the user for submitting an impermissible communication through the agent interface. In some instances, the automated artificial intelligence agent system may automatically terminate the communications session in response to the impermissible communication. In some instances, the automated artificial intelligence agent system may restrict user access to the artificial intelligence agent communication system in response to an impermissible communication. For example, the automated artificial intelligence agent system may add one or more restrictions to the user's account within the client service to prevent the user from accessing the artificial intelligence agent communication system for a period of time (e.g., one day, one week, one month, etc.). Further, these one or more restrictions may be defined according to the severity of the user's violation of any applicable rules. In some instances, the restrictions that are applied in response to an impermissible communication may be defined in conjunction with the set of embeddings corresponding to impermissible intents in the set of knowledge bases.

If the artificial intelligence agent communication system determines that the user query corresponds to a permissible intent or may otherwise be addressed by the automated artificial intelligence agent system, the automated artificial intelligence agent system, at step 812, may identify any known responses based on the set of query embeddings. For instance, the agent response generation LLM may compare, according to a set of similarity vectors, the set of query embeddings to the different sets of embeddings corresponding to the different data sources/knowledge bases maintained by the artificial intelligence agent communication system. For instance, the agent response generation LLM may perform clustering or classification of the user query embeddings to obtain partial matches among different data sources/knowledge bases to identify one or more data sources/knowledge bases that may be used to derive a response to the user query.

At step 814, the artificial intelligence agent communication system may determine whether the response that is to be provided to the user is a user-specific response that requires data that is unique to the user. For example, a response that denotes a user's existing account balance may require evaluation of a user account in order to incorporate the present account balance into the response. If an identified data source/knowledge base article denotes a need to incorporate additional information that is specific to the user, the artificial intelligence agent communication system, at step 816, may supplement the response with user-specific data. Returning to the earlier illustrative example regarding a user query regarding the user's present account balance, the artificial intelligence agent communication system may automatically access the user's account to determine the user's present account balance. The artificial intelligence agent communication system, through the agent response generation LLM, may revise the response obtained from the identified data source or knowledge base article to incorporate the obtained account balance.

At step 818, the artificial intelligence agent communication system may transmit the query response through the artificial intelligence agent communications session. For instance, the agent response generation LLM may transmit the query response to the automated artificial intelligence agent, which may update the agent interface to present the query response to the user. This may include producing a text-based response that is presented through a messaging window of the agent interface. Further, the automated artificial intelligence agent may produce an audial communication that incorporates the query response.

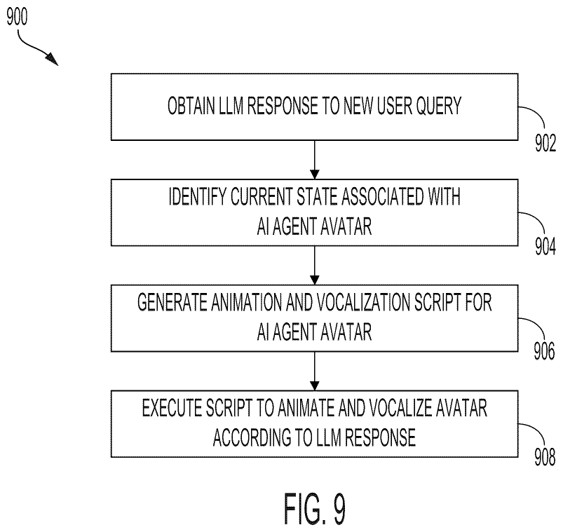

FIG. 9 shows an illustrative example of a process 900 for generating and executing a programmatic script to animate and vocalize a virtual agent avatar associated with an artificial intelligence agent based on a newly generated response in accordance with at least one embodiment. The process 900 may be performed by the agent avatar module described above in connection with FIG. 1. As noted above, the agent avatar module may automatically implement a virtual avatar of the automated artificial intelligence agent and that may be graphically represented through the agent interface. This virtual avatar may be configured to emulate the appearance of a human and may be animated to mimic human speech when providing audial responses through the agent interface. For example, the face (e.g., lips, mouth, eyes, etc.) and body of the virtual avatar graphically represented through the agent interface may move in unison with the audial responses generated through the agent avatar module to mimic actual human interaction.

At step 902, the agent avatar module may obtain an LLM response to a new user query. As noted above, the artificial intelligence agent communication system implements an agent response generation LLM that is trained to process user queries as these user queries are obtained and dynamically generate LLM responses to these user queries based on different data sources and knowledge bases maintained by the artificial intelligence agent communication system. As the agent response generation LLM generates responses to new user queries, the agent response generation LLM may automatically transmit these responses to the agent avatar module.

At step 904, the agent avatar module may identify the current state associated with the virtual avatar of the automated artificial intelligence agent. For instance, the agent avatar module may determine the present position or animation of the different virtual avatar features presented through the agent interface. This present position or animation may be used to determine an initial position for any new animation that is to be performed through the virtual avatar when communicating the LLM response to the user through the agent interface.

At step 906, the agent avatar module may generate an animation and vocalization script for the virtual avatar. For instance, the agent avatar module may generate a programmatic script according to the new response. This programmatic script may define configurable frame start/stop times, speed, looping, delays, durations, randomizing of animations, partial animations, and expression freezing for the virtual avatar. Further, the programmatic script may be defined according to the present position or animation of the virtual avatar displayed through the agent interface. The agent avatar module may define this script using any programmatic code (e.g., JavaScript, etc.) that is executable by the automated artificial intelligence agent to render and display the avatar animation through the agent interface.

At step 908, the agent avatar module may transmit the programmatic script to the automated artificial intelligence agent, which may execute the programmatic script to animate and vocalize the virtual avatar according to the LLM response. Through execution of this script, the virtual avatar may be animated to appear as though the avatar is vocalizing the response generated by the agent response generation LLM. Further, the virtual avatar may be animated such that the vocalization of the response through the virtual avatar has a natural cadence and appearance to the user. Additionally, execution of the script may cause the automated artificial intelligence agent to produce an audial communication of the response that is synchronized to the virtual avatar animations.

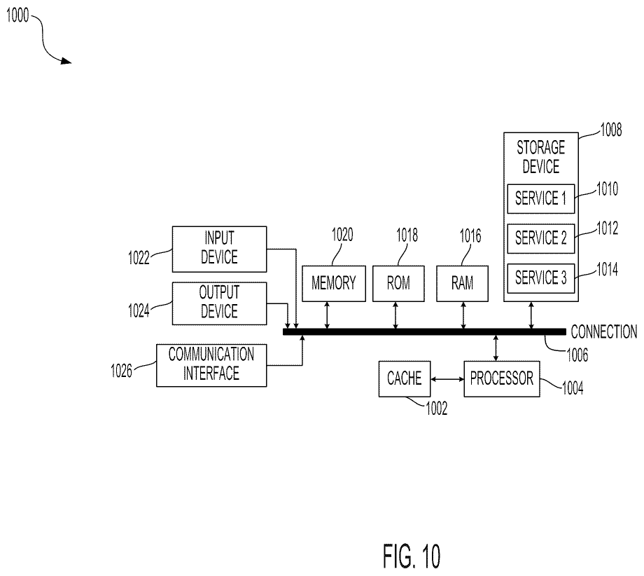

FIG. 10 illustrates a computing system architecture 1000 including various components in electrical communication with each other using a connection 1006, such as a bus, in accordance with some implementations. Example system architecture 1000 includes a processing unit (CPU or processor) 1004 and a system connection 1006 that couples various system components including the system memory 1020, such as ROM 1018 and RAM 1016, to the processor 1004. The system architecture 1000 can include a cache 1002 of high-speed memory connected directly with, in close proximity to, or integrated as part of the processor 1004. The system architecture 1000 can copy data from the memory 1020 and/or the storage device 1008 to the cache 1002 for quick access by the processor 1004. In this way, the cache can provide a performance boost that avoids processor 1004 delays while waiting for data. These and other modules can control or be configured to control the processor 1004 to perform various actions.

Other system memory 1020 may be available for use as well. The memory 1020 can include multiple different types of memory with different performance characteristics. The processor 1004 can include any general purpose processor and a hardware or software service, such as service 1 1010, service 2 1012, and service 3 1014 stored in storage device 1008, configured to control the processor 1004 as well as a special-purpose processor where software instructions are incorporated into the actual processor design. The processor 1004 may be a completely self-contained computing system, containing multiple cores or processors, a bus, memory controller, cache, etc. A multi-core processor may be symmetric or asymmetric.

To enable user interaction with the computing system architecture 1000, an input device 1022 can represent any number of input mechanisms, such as a microphone for speech, a touch-sensitive screen for gesture or graphical input, keyboard, mouse, motion input, speech and so forth. An output device 1024 can also be one or more of a number of output mechanisms known to those of skill in the art. In some instances, multimodal systems can enable a user to provide multiple types of input to communicate with the computing system architecture 1000. The communications interface 1026 can generally govern and manage the user input and system output. There is no restriction on operating on any particular hardware arrangement and therefore the basic features here may easily be substituted for improved hardware or firmware arrangements as they are developed.

Storage device 1008 is a non-volatile memory and can be a hard disk or other types of computer readable media which can store data that are accessible by a computer, such as magnetic cassettes, flash memory cards, solid state memory devices, digital versatile disks, cartridges, RAMs 1016, ROM 1018, and hybrids thereof.

The storage device 1008 can include services 1010, 1012, 1014 for controlling the processor 1004. Other hardware or software modules are contemplated. The storage device 1008 can be connected to the system connection 1006. In one aspect, a hardware module that performs a particular function can include the software component stored in a computer-readable medium in connection with the necessary hardware components, such as the processor 1004, connection 1006, output device 1024, and so forth, to carry out the function.

The disclosed methods can be performed using a computing system. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device. The processor may be configured to carry out all or part of methods described herein for example by executing code for example stored in memory. One or more of a user device or computer, a provider server or system, or a suspended database update system may include the components of the computing system or variations on such a system. In some embodiments, the disclosed methods can be performed using virtualized environments.

This disclosure contemplates the computer system taking any suitable physical form, including, but not limited to a Point-of-Sale system (“POS”). As example and not by way of limitation, the computer system may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud, which may include one or more cloud components in one or more networks. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor may be, for example, a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory can be coupled to the processor by, for example, a bus. The memory can include, by way of example but not limitation, random access memory (RAM), such as dynamic RAM (DRAM) and static RAM (SRAM). The memory can be local, remote, or distributed.

The bus can also couple the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor. In some embodiments, the data may be encrypted.

Software can be stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor. In some embodiments, the software may be encrypted.

The bus can also couple the processor to the network interface device. The interface can include one or more of a modem or network interface. It will be appreciated that a modem or network interface can be considered to be part of the computer system. The interface can include an analog modem, Integrated Services Digital network (ISDN modem, cable modem, token ring interface, satellite transmission interface (e.g., “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device.

In operation, the computer system can be controlled by operating system software that includes a file management system, such as a disk operating system. One example of operating system software with associated file management system software is the family of operating systems known as Windows® from Microsoft Corporation of Redmond, WA, and their associated file management systems. Another example of operating system software with its associated file management system software is the Linux™ operating system and its associated file management system. The file management system can be stored in the non-volatile memory and/or drive unit and can cause the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any system capable of executing a set of instructions (sequential or otherwise) that specify actions to be taken by that system.

While the machine-readable medium or machine-readable storage medium is shown, by way of example, to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually affect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting the subject matter to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

It is also noted that individual implementations may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Client devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things. The input devices can include, for example, a keyboard, a mouse, a key pad, a touch interface, a microphone, a camera, and/or other types of input devices. The output devices can include, for example, a display screen, a speaker, a haptic feedback system, a printer, and/or other types of output devices. A data storage device, such as a hard drive or flash memory, can enable the computing device to temporarily or permanently store data. A network interface, such as a wireless or wired interface, can enable the computing device to communicate with a network. Examples of computing devices include desktop computers, laptop computers, server computers, hand-held computers, tablets, smart phones, personal digital assistants, digital home assistants, as well as machines and apparatuses in which a computing device has been incorporated.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

The various examples discussed above may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments). A processor(s), implemented in an integrated circuit, may perform the necessary tasks.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method, comprising:
receiving a user query through an agent interface associated with an automated artificial intelligence agent, wherein the agent interface includes a text-based messaging window and a virtual avatar associated with the automated artificial intelligence agent;
processing the user query through a Natural Language Processing (NLP) system to generate a set of query embeddings;
processing the set of query embeddings through a response generation large language model (LLM) to identify a set of response embeddings, wherein the set of response embeddings corresponds to a set of data sources associated with the user query, and wherein the set of response embeddings is identified based on a comparison of different dimensional values associated with the set of query embeddings and the set of response embeddings according to a set of vectors of similarity;
generating a programmatic script for presenting a response to the user query, wherein the response is generated based on the set of response embeddings, and wherein the programmatic script defines configurable parameters associated with the virtual avatar; and
providing the programmatic script, wherein when the programmatic script is executed by the automated artificial intelligence agent, the agent interface is updated by the automated artificial intelligence agent to present the response through the text-based messaging window and the virtual avatar is animated according to the configurable parameters and in tandem with a vocalization of the response.

2. The computer-implemented method of claim 1, further comprising:
receiving a new user query through the agent interface;
determining, through the response generation LLM, that a new set of query embeddings corresponding to the new user query is associated with a known set of embeddings corresponding to impermissible intents; and
rejecting the new user query.

3. The computer-implemented method of claim 1, wherein the virtual avatar is modeled after a live human agent associated with a user of the agent interface.

4. The computer-implemented method of claim 1, further comprising:
receiving, through the agent interface, a request to transfer a communications session from the automated artificial intelligence agent to a live agent; and
dynamically updating the agent interface to replace the virtual avatar with a new window through which the live agent provides audiovisual communications to a user through the agent interface.

5. The computer-implemented method of claim 1, wherein:
the response includes an interactive document; and
the computer-implemented method further comprises:
updating the text-based messaging window to present the interactive document;
receiving user input through the interactive document; and
processing the user input and interactive document through the response generation LLM to perform one or more operations according to the user input.

6. The computer-implemented method of claim 1, further comprising:
monitoring user interactions with the automated artificial intelligence agent to obtain feedback corresponding to the response;
updating a dataset of sample user queries and sample responses to add a new data point corresponding to the user query and the response, wherein the new data point is annotated according to the feedback; and
processing the dataset through the response generation LLM to retrain the response generation LLM.

7. The computer-implemented method of claim 1, wherein the user query is an audial communication provided through selection of one or more user interface elements provided through the agent interface.

8. A system, comprising:
one or more processors; and
memory storing thereon instructions that, as a result of being executed by the one or more processors, cause the system to:
receive a user query through an agent interface associated with an automated artificial intelligence agent, wherein the agent interface includes a text-based messaging window and a virtual avatar associated with the automated artificial intelligence agent;
process the user query through a Natural Language Processing (NLP) system to generate a set of query embeddings;
process the set of query embeddings through a response generation large language model (LLM) to identify a set of response embeddings, wherein the set of response embeddings corresponds to a set of data sources associated with the user query, and wherein the set of response embeddings is identified based on a comparison of different dimensional values associated with the set of query embeddings and the set of response embeddings according to a set of vectors of similarity;
generate a programmatic script for presenting a response to the user query, wherein the response is generated based on the set of response embeddings, and wherein the programmatic script defines configurable parameters associated with the virtual avatar; and
provide the programmatic script, wherein when the programmatic script is executed by the automated artificial intelligence agent, the agent interface is updated by the automated artificial intelligence agent to present the response through the text-based messaging window and the virtual avatar is animated according to the configurable parameters and in tandem with a vocalization of the response.

9. The system of claim 8, wherein the instructions further cause the system to:
receive a new user query through the agent interface;
determine, through the response generation LLM, that a new set of query embeddings corresponding to the new user query is associated with a known set of embeddings corresponding to impermissible intents; and
reject the new user query.

10. The system of claim 8, wherein the virtual avatar is modeled after a live human agent associated with a user of the agent interface.

11. The system of claim 8, wherein the instructions further cause the system to:
receive, through the agent interface, a request to transfer a communications session from the automated artificial intelligence agent to a live agent; and
dynamically update the agent interface to replace the virtual avatar with a new window through which the live agent provides audiovisual communications to a user through the agent interface.

12. The system of claim 8, wherein:
the response includes an interactive document; and
the instructions further cause the system to:
update the text-based messaging window to present the interactive document;
receive user input through the interactive document; and
process the user input and interactive document through the response generation LLM to perform one or more operations according to the user input.

13. The system of claim 8, wherein the instructions further cause the system to:
monitor user interactions with the automated artificial intelligence agent to obtain feedback corresponding to the response;
update a dataset of sample user queries and sample responses to add a new data point corresponding to the user query and the response, wherein the new data point is annotated according to the feedback; and
process the dataset through the response generation LLM to retrain the response generation LLM.

14. The system of claim 8, wherein the user query is an audial communication provided through selection of one or more user interface elements provided through the agent interface.

15. A non-transitory computer-readable storage medium storing thereon executable instructions that, as a result of being executed by one or more processors of a computer system, cause the computer system to:
receive a user query through an agent interface associated with an automated artificial intelligence agent, wherein the agent interface includes a text-based messaging window and a virtual avatar associated with the automated artificial intelligence agent;
process the user query through a Natural Language Processing (NLP) system to generate a set of query embeddings;
process the set of query embeddings through a response generation large language model (LLM) to identify a set of response embeddings, wherein the set of response embeddings corresponds to a set of data sources associated with the user query, and wherein the set of response embeddings is identified based on a comparison of different dimensional values associated with the set of query embeddings and the set of response embeddings according to a set of vectors of similarity;
generate a programmatic script for presenting a response to the user query, wherein the response is generated based on the set of response embeddings, and wherein the programmatic script defines configurable parameters associated with the virtual avatar; and
provide the programmatic script, wherein when the programmatic script is executed by the automated artificial intelligence agent, the agent interface is updated by the automated artificial intelligence agent to present the response through the text-based messaging window and the virtual avatar is animated according to the configurable parameters and in tandem with a vocalization of the response.

16. The non-transitory computer-readable storage medium of claim 15, wherein the executable instructions further cause the computer system to:
receive a new user query through the agent interface;
determine, through the response generation LLM, that a new set of query embeddings corresponding to the new user query is associated with a known set of embeddings corresponding to impermissible intents; and
reject the new user query.

17. The non-transitory computer-readable storage medium of claim 15, wherein the virtual avatar is modeled after a live human agent associated with a user of the agent interface.

18. The non-transitory computer-readable storage medium of claim 15, wherein the executable instructions further cause the computer system to:
receive, through the agent interface, a request to transfer a communications session from the automated artificial intelligence agent to a live agent; and
dynamically update the agent interface to replace the virtual avatar with a new window through which the live agent provides audiovisual communications to a user through the agent interface.

19. The non-transitory computer-readable storage medium of claim 15, wherein:
the response includes an interactive document; and
the executable instructions further cause the computer system to:
update the text-based messaging window to present the interactive document;
receive user input through the interactive document; and
process the user input and interactive document through the response generation LLM to perform one or more operations according to the user input.

20. The non-transitory computer-readable storage medium of claim 15, wherein the executable instructions further cause the computer system to:
monitor user interactions with the automated artificial intelligence agent to obtain feedback corresponding to the response;
update a dataset of sample user queries and sample responses to add a new data point corresponding to the user query and the response, wherein the new data point is annotated according to the feedback; and
process the dataset through the response generation LLM to retrain the response generation LLM.

21. The non-transitory computer-readable storage medium of claim 15, wherein the user query is an audial communication provided through selection of one or more user interface elements provided through the agent interface.
